(19) United States
(12) Patent Application Publication
(10) Pub. No.: US 2013/0258394 A1
(43) Pub. Date: Oct. 3, 2013

(54) PRINTING APPARATUS

(71) Applicant: BROTHER KOGYO KABUSHIKI KAISHA, Nagoya-shi (JP)

(72) Inventor: Tetsuya ISHIYAMA, Chita-shi (JP)

(73) Assignee: BROTHER KOGYO KABUSHIKI KAISHA, Nagoya-shi (JP)

(21) Appl. No.: 13/851,292

(22) Filed: Mar. 27, 2013

(30) Foreign Application Priority Data
Apr. 3, 2012 (JP) 2012-084494

(51) Int. Cl. G06K 15/00

(52) U.S. Cl. CPC G06K 15/4055
USPC 358/1.14

(57) ABSTRACT

When a power switch key is operated to turn off a printing apparatus currently set in power-on state and voltage value of a battery in this situation lowers 6.9 V, a display of LCD is turned out and operation keys except for the power switch key are locked so that the printing apparatus is placed in seeming power-off state. If the operation key is thereafter operated under seeming power-off state and voltage value of the battery in this situation lowers 6.9 V, the display of LCD is turned on and the operation keys are unlocked so that the printing apparatus is placed in power-on state from seeming power-off state. Accordingly, even if the printing apparatus is set in seeming power-off state due to significant drop in voltage of the battery, the printing apparatus can be placed in power-on state immediately upon operation of the power switch key.

### CROSS REFERENCE TO RELATED APPLICATIONS

The present application claims priority from Japanese Patent Application No. JP 2012-084494, which was filed on Apr. 3, 2012, the disclosure of which is incorporated herein by reference in its entirety.

### TECHNICAL FIELD

The disclosure relates to a printing apparatus of which drive source is a battery.

### BACKGROUND

Regarding a printing apparatus of which drive source is a battery, there has conventionally been known that voltage of a battery drops during printing, whereas, in a state of less load at the battery, namely, in a case where printing is not carried out for a while, the voltage thereof returns to normal level automatically along passage of time.

Depending on kinds of batteries used as drive source, there have been some batteries that take long time to get voltage thereof back to normal level. In using such batteries as drive source, there has occurred malfunction such that the power is not turned on, in a case where the power is turned off in a state that voltage of the battery significantly drops immediately after continuous printing operations and a power switch is depressed immediately after the power off. That is, despite depression of the power switch, in this situation, the controller thereof determines that the power cannot be turned on because the battery does not get back enough voltage level to turn on the power. The above such malfunction causes a user to: change the not-run-down battery with a new one; feel troublesome to have to change batteries often; recharge wastefully in using a rechargeable battery; and to soon use up the rechargeable battery as reaching rechargeable limitation.

### SUMMARY

The disclosure has been made to solve the above-described problem and has an object to provide a printing apparatus capable of setting itself in power-on state immediately even from power-off state in which voltage of a battery, a drive source for the apparatus, has dropped significantly.

To achieve the purpose of the disclosure, there is provided a printing apparatus that uses a battery as drive source for printing and allows a processor to control the printing in such a manner that, even if a power switch key is operated to turn on the printing apparatus being set in power-off state, the processor maintains the power-off state of the printing apparatus when voltage value of the drive source lowers predetermined value, wherein, when the power switch key is operated to turn off the printing apparatus being set in power-on state, depending on the voltage value of the drive source, the processor executes one of operations to: (1) set the printing apparatus in power-off state if the voltage value of the drive source is equal to or higher than the predetermined value; or (2) turn out a display of the printing apparatus and lock operation keys thereof except for the power switch key if the voltage value of the drive source lowers the predetermined value, and wherein, after the display is turned out and the operation keys except for the power switch key are locked, depending on conditions including the voltage value of the drive source, the processor executes one of operations to: (A) set the printing apparatus in power-off state if the voltage value of the drive source gets back to the predetermined value; or (B) turn on the display and release lock of the operation keys if the voltage value of the drive source lowers the predetermined value and the power switch is operated to turn on the printing apparatus.

To achieve the purpose of the disclosure, there is further provided a printing apparatus that uses a battery as drive source for printing and allows a processor to control the printing in such a manner that, even if a power switch key is operated to turn on the printing apparatus being set in power-off state, the processor maintains the power-off state of the printing apparatus when voltage value of the drive source lowers predetermined value, wherein, when the power switch key is operated to turn off the printing apparatus being set in power-on state, the processor turns out a display of the printing apparatus and locks operation keys thereof except for the power switch key, depending on conditions including the voltage value of the drive source, thereafter the processor executes one of operations to: (A) set the printing apparatus in power-off state if the voltage value of the drive source gets back to the predetermined value; or (B) turn on the display and release lock of the operation keys if the voltage value of the drive source lowers the predetermined value and the power switch is operated to turn on the printing apparatus.

### BRIEF DESCRIPTION OF THE DRAWINGS

FIG. 1 is a perspective view of a printing apparatus directed to an embodiment of the disclosure;

FIG. 2 is a block diagram of the printing apparatus;

FIG. 3 is a flowchart of the printing apparatus;

FIG. 4 is another flowchart of the printing apparatus; and

FIG. 5 is still another flow chart of the printing apparatus.

### DETAILED DESCRIPTION

A detailed description of an exemplary embodiment of a printing apparatus embodying the disclosure will now be given referring to the accompanying drawings.

### 1. CONFIGURATION OF THE DISCLOSURE

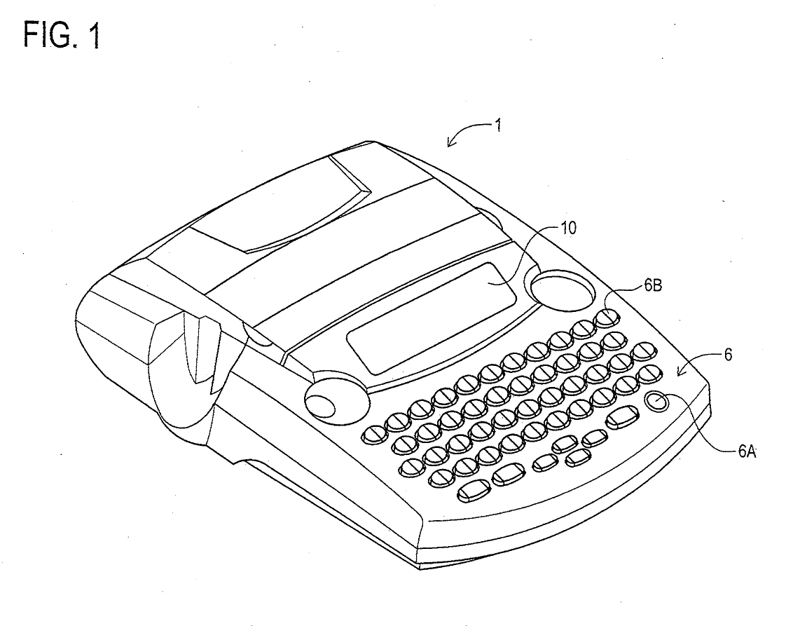

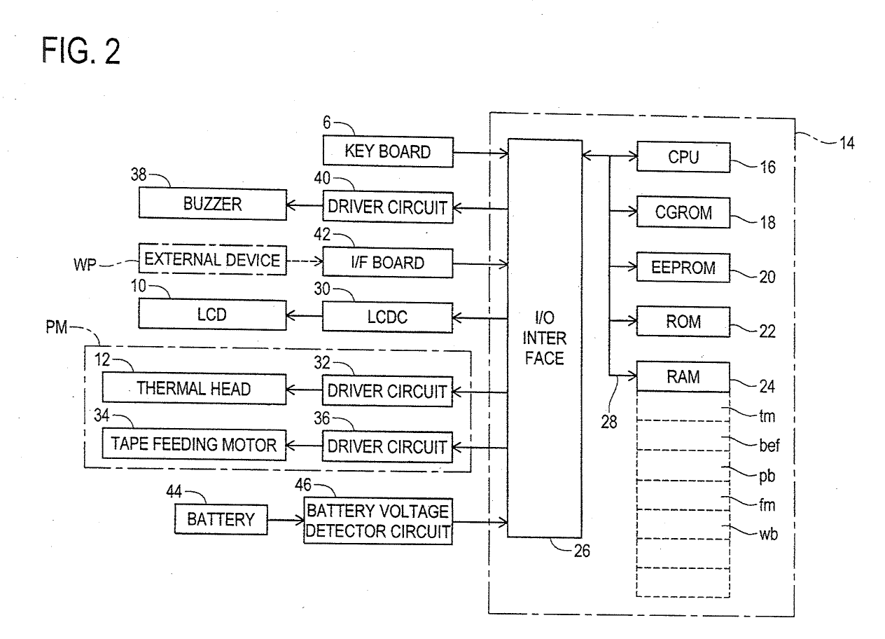

A printing apparatus directed to an embodiment of the disclosure will be described in detail by referring to FIG. 1 and FIG. 2. The printing apparatus directed to the present embodiment is a so-called desktop label printer.

As primary core of control system, the printing apparatus 1 includes a processor 14 consisting of a central processing unit (termed as CPU hereinafter) 16, a pattern data memory (termed as CGROM hereinafter) 18, an EEPROM 20, a ROM 22, a RAM 24, an input-output interface 26 and busses 28 for connecting those items.

What are connected to the input-output interface 26 are: a key board 6, a display controller (termed as LCDC hereinafter) 30 equipped with a display-purpose RAM for outputting display data to an LCD 10; a driver circuit 32 for driving a thermal head 12; a driver circuit 36 for driving a tape feeding motor 34 that serves to rotate plural spools and various rollers so as to feed a printing tape to the outside, the plural spools each being furnished with the printing tape, an ink ribbon, a double-sided tape, etc., in a rolled state; a driver circuit 40 for driving a warning buzzer 38; and an interface board (termed as IIF board herein after) 42 as unit for receiving document data sent from an external device WP such as word processor, etc. A printing mechanism PM consists of the thermal head 12, the driver circuit 32, the tape feeding motor 34 and the driver circuit 36.

The key board 6 of the printing apparatus I consists of a power switch key 6A, a print key 6B, various operation keys, etc.

The printing apparatus 1 uses a battery 44 for supplying power to each constituent electric device and includes a battery voltage detector circuit 46 for detecting voltage of the battery 44. A battery housing portion of the printing apparatus 1 houses the battery 44 in a replaceable manner.

The CGROM 18 stores dot pattern data for displaying characters each associated with corresponding code data. The EEPROM 20 stores outline data for defining outline of each character associated with code data in accordance with classification of font styles such as Gothic styles, Mincho styles, etc.

The RAM 24 is divided into various memory regions. For instance, the RAM 24 includes a text memory tm that stores various kinds of documentation data consisting of code data and character-size setting data with respect to characters, signs and the like to be inputted with the key board 6, character decoration data for defining font style data and various printing style information relating to landscape directional printing or portrait directional printing. The RAM 24 further includes: a printing buffer pb for storing dot pattern data of plural characters and signs of which images have been developed; a working buffer wb to be used during control processes; a flag memory fm for storing flag data necessary to respective control processes; and a buttery-empty flag bef for indicating battery empty or not.

The ROM 22 of the printing apparatus 1 stores a display drive control program, an image development process control program, a print drive control program, a print-on-tape control program and a to-be-later-described program peculiar to the disclosure. More specifically, the display drive control program is a program for controlling LCDC 30 so that characters, signs, etc. having been inputted with the key board 6 are associated with corresponding code data. The image development process control program is a program for executing image development in the printing buffer pb by converting outline data of corresponding code data in the text memory tm into printing dot pattern data in accordance with printing style information. The print drive control program is a program for controlling drive of the thermal head 12 and the tape feeding motor 34 by subsequently reading data in the printing buffer pb.

### 2. OPERATION OF THE DISCLOSURE

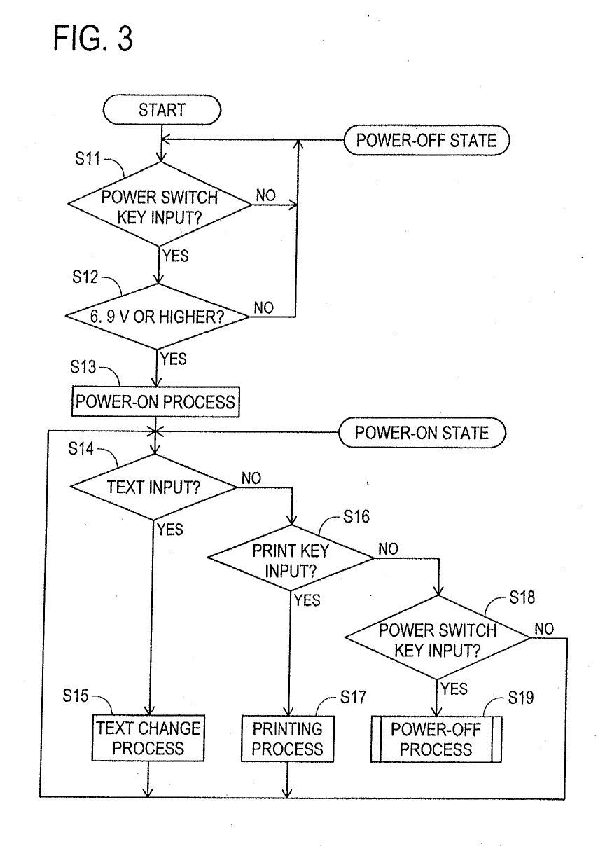

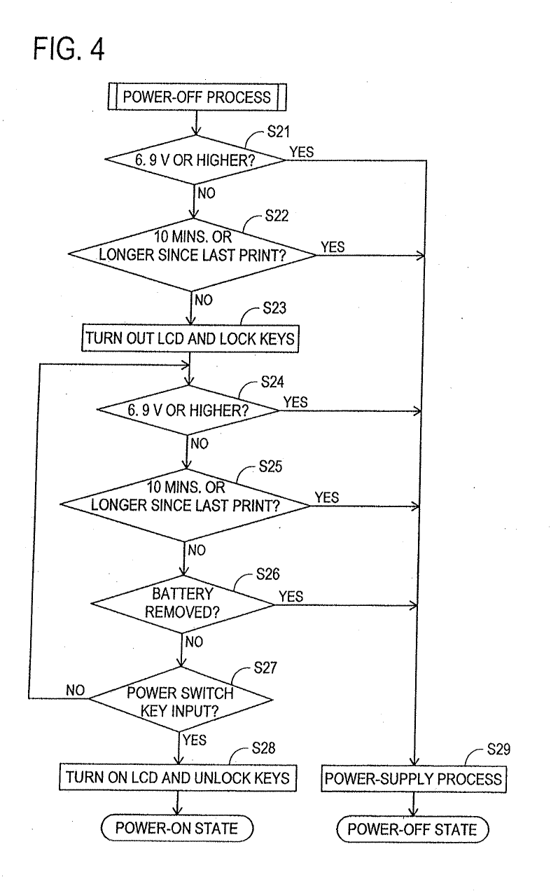

Regarding the thus configured printing apparatus 1, there will be described on control processes executed by the CPU 16 of the processor 14 in accordance with voltage change of the battery 44, etc. by referring to flowcharts shown in FIG. 3 and FIG. 4.

As shown in FIG. 3, regarding the printing apparatus 1 being set in power-off state, the CPU 16 firstly determines whether or not the power switch key 6A is inputted at S11. This determination process is made based on an input of a signal from the key board 6. If no input of the power switch key 6A is detected (S11: NO), the CPU 16 repeats the S11 with respect to the printing apparatus 1 being set in power-off state. If an input of the power switch key 6A is detected (S11: YES), the CPU 16 shifts the process to S12.

At S12, the CPU 16 determines whether or not voltage value of the battery 44 is equal to or higher than 6.9 V while the printing apparatus 1 is continuously set in power-off state. At this determination process, voltage value of the battery 44 is detected by the battery voltage detector circuit 46. If voltage value of the battery 44 lowers 6.9 V (S12: NO), the CPU 16 repeats the processes of S11 and S12 with the printing apparatus 11 being set in power-off state continuously. If voltage values of the battery 44 is equal to or higher than 6.9 V (S12: YES), the CPU 16 shifts the process to S13 at which the printing apparatus 1 is switched to power-on state.

Under the power-off state, the CPU 16 sets itself in low power consumption mode so as to consume electric power at its minimum possible amount for its operation and power is supplied to limited number of devices such as the ROM 22, the RAM 24, etc., whereby power consumption of the printing apparatus 1 in its entirety is kept small. Meanwhile, under the power-on state, the CPU 16 sets itself in high power consumption mode and power consumption of the CPU 16 itself becomes large. At the same time, power is supplied to various devices so as to be able to work immediately and power consumption of the printing apparatus 1 in its entirety gets large.

At S13, the CPU 16 sets the printing apparatus 1 in stand-by mode. After that, the CPU 16 shifts the process to S14.

At S14, the CPU 16 determines whether or not a text is inputted. This determination process is executed in accordance with an input of a signal from the key board 6, the I/F board 42 and the like. If an input of a text is detected (S14: YES), the CPU 16 shifts the process to S15.

At S15, the CPU 16 executes a text change process. This process is executed at the RAM 24. After that, the CPU 16 returns the process to S14. If no input of a text is detected (S14: NO), the CPU 16 shift the process to S16.

At. S16, the CPU 16 determines whether or not the print key 6B is inputted. This determination process is executed in accordance with an input signal from the key board 6. If an input of the print key 6B is detected (S16: YES), the CPU 16 shifts the process to S17.

At S17, the CPU 16 executes a printing process. This process is executed by the printing mechanism PM, etc. After that, the CPU 16 returns the process to S14. If no input of the print key 6B is detected (S16: NO), the CPU 16 shifts the process to S18.

At S18, the CPU 16 determines whether or not the power switch key 6A is inputted. This determination process is executed in accordance with an input signal from the key board 6. If no input of the power switch key 6A is detected (S18: NO), the CPU 16 repeats processes to follow S14. If an input of the power switch key 6A is detected (S18: YES), the CPU 16 shifts the process to S19.

At S19, the CPU 16 executes a power-off process: At this process, the CPU 16 firstly determines whether or not voltage value of the battery 44 is equal to or higher than 6.9 V at S21 shown in FIG. 4. At this determination process, voltage value of the battery 44 is detected by the battery voltage detector circuit 46. If voltage values of the battery 44 is equal to or higher than 6.9 V (S21: YES), the CPU 16 shifts the process to S29 at which the CPU 16 executes a power-supply stop process. An execution of the power-supply stop process is to stop supplying power to the LCD 10 and the LCDC 30. Therefore, display of the LCD 10 is completely turned out without arranging a specific control process to turn out the display. The execution of the power-supply stop process also stops supplying power to the key board 6, whereby keys other than the power-switch key 6A are made inactive so as to place the key board 6 in substantially key-locked state without arranging a specific control process to lock keys. The CPU 16 thus executes the power-supply stop process. Thereby, the printing apparatus 1 is placed in power-off state from power-on state. If voltage value of the battery 44 lowers 6.9 V (S21: NO), the CPU 16 shifts the process to S22.

At S22, the CPU 16 determines whether or not 10 minutes or longer time has passed since last print done at S17. At this determination process, passage of time is measured by timer mechanism inclusive of the CPU 16 or a timer program stored in the ROM 22, etc. If 10 minutes or longer time has passed since last print done at S17 (S21: YES), the CPU 16 shifts the process to S29 at which the CPU 16 executes the power-supply stop process. Thereby, the printing apparatus 1 is placed in power-off state from power-on state. If 10 minutes or longer time has not passed since last print done at S17 (S21: NO), the CPU 16 shifts the process to S23.

At S23, the CPU 16 turns out display of the LCD 10 and locks operation keys of the key board 6, except for the power switch key 6A. Thereby, the printing apparatus 1 is placed in seeming power-off state from the power-on state. After that, the CPU 16 shifts the process to S24.

At S24, the CPU 16 determines whether or not voltage value of the battery 44 is equal to or higher than 6.9 V. At this determination process, voltage value of the battery 44 is detected by the battery voltage detector circuit 46. If voltage values of the battery 44 is equal to or higher than 6.9 V (S24: YES), the CPU 16 shifts the above process to S29 at which the CPU 16 executes the power-supply stop process. At this moment, the printing apparatus 1 is placed in complete power-off state from seeming power-off state. If voltage value of the battery 44 lowers 6.9 V (S24: NO), the CPU 16 shifts the process to S25.

At S25, the CPU 16 determines 10 minutes or longer time has passed since last print done at S17. At this determination process, passage of time is measured by the timer mechanism inclusive of the CPU 16 or the timer program stored in the ROM 22, etc. If 10 minutes or longer time has passed since last print done at S17 (S25: YES), the CPU 16 shifts the above process to S29 at which the CPU 16 executes the power-supply stop process. At this moment, the printing apparatus 1 is placed in complete power-off state from seeming power-off state. If. 10 minutes or longer time has not passed since last print done at S17 (S25: NO), the CPU 16 shifts the process to S26.

At S26, the CPU 16 determines whether or not the battery 44 is removed from the printing apparatus 1. This determination process is executed in accordance with a detection signal from the battery voltage detector circuit 46. If the battery 44 is removed from the printing apparatus 1 (S26: YES), the CPU 16 shifts the process to S29 at which the CPU 16 executes the power-supply stop process. At this moment, the printing apparatus 1 is placed in complete power-off state from seeming power-off state. If the battery 44 is not removed from the printing apparatus 1 (S26: NO), the CPU 16 shifts the process to S27. It is to be noted that, even if the battery 44 is removed, the CPU 16 can work for a while owing to power accumulated in a capacitor installed on a substrate. Alternatively, the printing apparatus 1 may include another supplemental battery for saving to-be recorded data in the RAM 24 independent from the battery 44 so that the supplemental battery can supply power only when the battery 44 is removed.

At S27, the CPU 16 determines whether or not the power switch key 6A is inputted at S11. This determination process is executed in accordance with an input signal from the key board 6. If no input of the power switch key 6A (S27: NO), the CPU 16 repeats the processes to follow S24. If an input of the power switch key 6A is detected (S27: YES), the CPU 16 shifts the process to S28.

At S28, the CPU 16 turns on display of the LCD 10 and unlocks operation keys of the key board 6. Thereby, the printing apparatus 1 is placed in power-on state from seeming power-off state. After that, the CPU 16 repeats the processes to follow S13 shown in above FIG. 3. Meanwhile, the CPU 16 repeats the processes to follow S11 shown in above FIG. 3 after the printing apparatus 1 is placed in complete power-off state at above S29.

### 3. SUMMARY

In the printing apparatus 1 of the present embodiment, the CPU 16 of the processor 14 controls printing of which drive source is the battery 44 (S17). Even if the power switch key 6A is operated with the printing apparatus 1 being set in power-off state (S11: YES) to turn on the power, the CPU 16 of the processor 14 continuously sets the printing apparatus 1 in power-off state as long as voltage value of the battery 44, the drive source of printing, lowers 6.9 V (S12: NO).

In a case where the power switch key 6A is operated under the power-on state (S18: YES) to turn off the power, depending on voltage value of the battery 44 at S21, there are two of procedural options (1) and (2) after S21: (1) if voltage value of the battery 44 being the drive source of the printing apparatus 1 is equal to or higher than 6.9 V (S21: YES), the CPU 16 of the processor 14 sets the printing apparatus 1 in power-off state (S29); and (2) if voltage value of the battery 44 being the drive source of the printing apparatus 1 lowers 6.9 V (S21: NO), the CPU 16 of the processor 14 turns out display of the LCD 10 and locks the operation keys of the key board 6 except for the power switch key 6A (S23).

After through S23 in which the CPU 16 of the processor 14 turns out display of the LCD 10 and locks the operation keys of the key board 6 except for the power switch key 6A, depending on voltage value of the battery 44 at S24, there are two of procedural options (A) and (B) after S24: (A) if voltage value of the battery 44 being the drive source of the printing apparatus 1 gets back to level equal to or higher than 6.9 V (S24: YES), the CPU 16 of the processor 14 sets the printing apparatus 1 in power-off state (S29); and (B) if voltage value of the battery 44 being the drive source of the printing apparatus 1 lowers 6.9 V (S24: NO) and the power switch key 6A is operated (S27: YES) to turn on the power, the CPU 16 of the processor 14 turn on display of the LCD 10 and unlocks the operation keys of the key board 6 (S28).

In the printing apparatus 1 of the present embodiment, if the power switch key 6A is operated with the printing apparatus 1 being set in the power-on state (S18: YES) to turn off the power, the CPU 18 shifts the process to S19, namely, the power-supply stop process. At the power-supply stop process, (2) if voltage value of the battery 44 being the drive source of the printing apparatus 1 lowers 6.9 V (S21: NO), the CPU 16 of the processor 14 turns out display of the LCD 10 and locks the operation keys of the key board 6 except for the power switch key 6A (S23). Thereby, the printing apparatus 1 is set in seeming power-off state. However, after through S23, (B) if voltage value of the battery 44 being the drive source of the printing apparatus 1 lowers 6.9 V (S24: NO) and the power switch key 6A is operated (S27: YES) to turn on the power, the CPU 16 of the processor 14 turn on display of the LCD 10 and unlocks the operation keys of the key board 6 (S28). Thereby the printing apparatus 1 is placed in power-on state from seeming power-off state.

Accordingly, in the printing apparatus 1 of the present embodiment, even if voltage value of the battery 44 being the drive source of the printing apparatus 1 has dropped significantly (S21: NO) and the printing apparatus 1 is consequently set in seeming power-off state (S23), an operation of the power switch key (S27: YES) can immediately set the printing apparatus 1 in power-on state (S28).

Further, in the printing apparatus 1 of the present embodiment, if the power switch key 6A is operated with the printing apparatus 1 being set in power-on state (S18: YES) to turn off the power and 10 minutes have passed since last print done at above S17 (S22: YES), the CPU 16 of the processor 14 places the printing apparatus 1 in power-off state (S29). Practically, as 10 minutes have passed since last-done print process at above S17 (S22: YES), voltage value of the battery 44, the drive source for the printing apparatus 1, is expected to approximate 6.9 V. Accordingly, in the printing apparatus 1 of the present embodiment, regardless of voltage value of the battery 44 being the drive source of the printing apparatus 1, passage of predetermined length of time since last print done at above S17 places the printing apparatus 1 in power-off state. Thereby, when the power switch key 6A is operated with the printing apparatus 1 being set in power-off state (S11: YES) to turn on the power, the printing apparatus 1 can be set in power-on state immediately (S12: YES).

Further, in the printing apparatus 1 of the present embodiment, even if a series of processes goes such that the power switch key 6A is operated with the printing apparatus 1 being set in power-on state (S18: YES) to turn the power off, the display of the LCD 10 is turned out and operation keys of the key board 6 are locked except for power switch key 6A (S23) and voltage value of the battery 44 being the drive source of the printing apparatus 1 lowers 6.9 V (S24: NO), passage of predetermined length of time, namely, 10 minutes, since last print done at above S17 (S25: YES) places the printing apparatus 1 in power-off state (S29). Practically, as 10 minutes have passed since last print done at above S17 (S25: YES), voltage value of the battery 44, the drive source for the printing apparatus 1, is expected to approximate 6.9 V. Accordingly, in the printing apparatus 1 of the present embodiment, even if voltage value of the battery 44 being the drive source of the printing apparatus 1 has dropped significantly (S24: NO) and the printing apparatus 1 is set in power-off state (S29), an operation of the power switch key (S11: YES) can immediately set the printing apparatus 1 in power-on state (S12: YES).

Further, regarding predetermined voltage value used at above S12, above S21 and above S24 in the printing apparatus 1 of the present embodiment, instead of 6.9 V, there may be used another voltage value for detecting incorrect loading of the battery 44 being the drive source of the printing apparatus 1. In the case of using another voltage value, incorrect loading of the battery 44 does not place the printing apparatus 1 in power-on state (S12: NO) even if the power switch key 6A is operated with the printing apparatus 1 in power-off state to turn on the power. Thereby, incorrect loading of the battery 44 being the drive source can be avoided.

Further, regarding predetermined voltage value used at above S12, above S21 and above S24 in the printing apparatus 1 of the present embodiment, the voltage value of 6.9 V is proper one for securing normal printing quality with the battery 44 being the drive source of the printing apparatus 1. Therefore, as long as printing is configured to be processed when the printing apparatus 1 is set in power-on state (S17), deterioration of print quality due to voltage drop of the battery 44 can be avoided.

Further, in a case where the printing apparatus 1 of the present embodiment uses a nickel hydrogen rechargeable battery as practical example of battery 44 being the drive source of the printing apparatus 1, the above described working effects are significantly exercised because a nickel hydrogen rechargeable battery takes considerably long time to automatically get back its voltage level for proper print process.

### 4. OTHER

It is to be noted that the disclosure is not restricted to aspects according to the present embodiment and that various changes and modification may be made without departing from the gist of the disclosure.

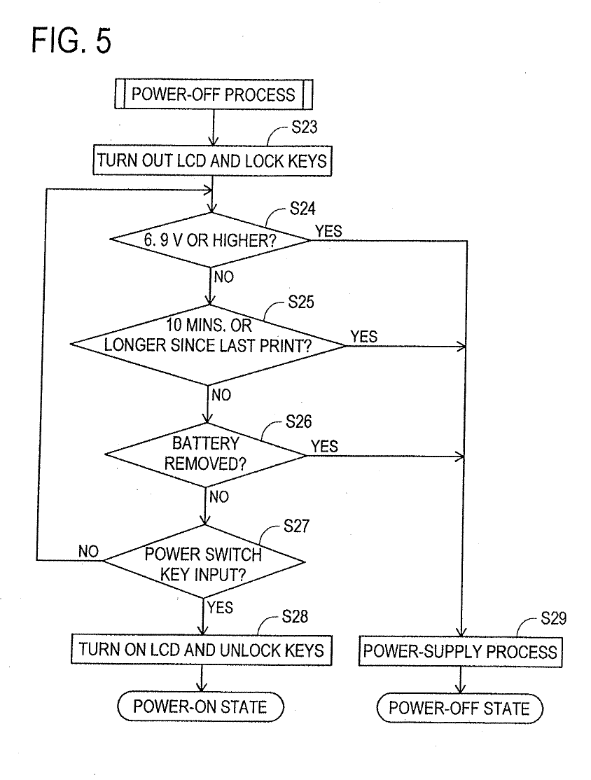

For instance, a display for the printing apparatus 1 of the present embodiment is not restricted to the LCD (liquid crystal display) 10. The procedural order of S21, S22 and S23 may be changed among them. Further, as shown in FIG. 5, the processes of S21 and S22 may be omitted. The procedural order of S24, S25 and S26 may be changed among them.

The power-supply stop process at S29 turns out display of the LCD 10 and inactivates keys except for the power-switch key 6A. Independent from the power-supply stop process, there may be separately arranged a control process to turn out display of the LCD 10 and a control process to lock keys except for power switch key 6A.

Instead of the single power-switch key 6A, a power-on key and a power-off key may be arranged separately. Length of predetermined time is not restricted to 10 minutes as long as it is long enough for a battery to get back its proper voltage level.

While presently exemplary embodiments have been shown and described, it is to be understood that this disclosure is for the purpose of illustration and that various changes and modifications may be made without departing from the scope of the disclosure as set forth in the appended claims.

What is claimed is:

1. A printing apparatus that uses a battery as drive source for printing and allows a processor to control the printing in such a manner that, even if a power switch key is operated to turn on the printing apparatus being set in power-off state, the processor maintains the power-off state of the printing apparatus when voltage value of the drive source lowers predetermined value,
wherein, when the power switch key is operated to turn off the printing apparatus being set in power-on state, depending on the voltage value of the drive source, the processor executes one of operations to:
(1) set the printing apparatus in power-off state if the voltage value of the drive source is equal to or higher than the predetermined value; or
(2) turn out a display of the printing apparatus and lock operation keys thereof except for the power switch key if the voltage value of the drive source lowers the predetermined value, and
wherein, after the display is turned out and the operation keys except for the power switch key are locked, depending on conditions including the voltage value of the drive source, the processor executes one of operations to:
(A) set the, printing apparatus in power-off state if the voltage value of the drive source gets back to the predetermined value; or
(B) turn on the display and release lock of the operation keys if the voltage value of the drive source lowers the predetermined value and the power switch is operated to turn on the printing apparatus.

2. The printing apparatus according to claim 1, wherein, when the power switch key is operated to turn off the printing apparatus being set in power-on state, the processor executes an operation to place the printing apparatus in power-off state if predetermined length of time has passed since last-done printing.

3. The printing apparatus according to claim 1, wherein, in a case that the power switch key is operated to turn off the printing apparatus being set in power-on state, after the display is turned out and the operation keys except for the power switch key are locked and even if the voltage value of the drive source lowers the predetermined value, the processor executes an operation to place the printing apparatus in power-off state on condition that the predetermined length of time has passed since last-done printing.

4. The printing apparatus according to claim 1, wherein the predetermined value is voltage value for detecting incorrect loading of the battery as the drive source.

5. The printing apparatus according to claim 1, wherein the predetermined value is voltage value for securing normal quality in the printing with use of the battery as the drive source.

6. The printing apparatus according to claim 1, wherein the battery as the drive source is a nickel hydrogen rechargeable battery.

7. A printing apparatus that uses a battery as drive source for printing and allows a processor to control the printing in such a manner that, even if a power switch key is operated to turn on the printing apparatus being set in power-off state, the processor maintains the power-off state of the printing apparatus when voltage value of the drive source lowers predetermined value,
wherein, when the power switch key is operated to turn off the printing apparatus being set in power-on state, the processor turns out a display of the printing apparatus and locks operation keys thereof except for the power switch key, depending on conditions including the voltage value of the drive source, thereafter the processor executes one of operations to:
(A) set the printing apparatus in power-off state if the voltage value of the drive source gets back to the predetermined value; or
(B) turn on the display and release lock of the operation keys if the voltage value of the drive source lowers the predetermined value and the power switch is operated to turn on the printing apparatus.

8. The printing apparatus according to claim 7, wherein, in a case that the power switch key is operated to turn off the printing apparatus being set in power-on state, after the display is turned out and the operation keys except for the power switch key are locked and even if the voltage value of the drive source lowers the predetermined value, the processor executes an operation to place the printing apparatus in power-off state on condition that the predetermined length of time has passed since last-done printing.

9. The printing apparatus according to claim 7, wherein the predetermined value is voltage value for detecting incorrect loading of the battery as the drive source.

10. The printing apparatus according to claim 7, wherein the predetermined value is voltage value for securing normal quality in the printing with use of the battery as the drive source.

11. The printing apparatus according to claim 7, wherein the battery as the drive source is a nickel hydrogen rechargeable battery.
